(19) United States
(12) Patent Application Publication
(10) Pub. No.: US 2015/0041094 A1
(43) Pub. Date: Feb. 12, 2015

(54) CORE PIN DETECTION

(71) Applicant: Ippei Yoshimura, Villa Rica, GA (US)

(72) Inventor: Ippei Yoshimura, Villa Rica, GA (US)

(73) Assignee: HONDA MOTOR CO., LTD., Tokyo (JP)

(21) Appl. No.: 13/960,265

(22) Filed: Aug. 6, 2013

(51) Int. Cl. G01B 5/008

(52) U.S. Cl. CPC G01B 5/008
USPC 164/4.1; 33/503

(57) ABSTRACT

A method of manufacturing a case part using a die with at least one core pin to form the cast part with at least one receptacle, where the method includes an automated inspection process that inspects the receptacle for quality control using a coordinate measurement machine, and where the inspection process can also automatically determine whether the core pin is bent or broken.

### BACKGROUND

This application relates generally to a method of manufacturing a casting using core pins on a die, and more particularly to a method and apparatus for manufacturing a cast part having at least one core pin receptacle using a die with a corresponding at least one core pin and using an inspection process for measuring the receptacle to detect situations where the process has fallen out of tolerance for quality control.

Core pin receptacles are provided in various castings during manufacturing to facilitate the assembly of components for various purposes, such as to provide a receptacle to be tapped for receiving bolts or other fasteners for fastening other parts to the cast part, or vice versa. In such a process, one or more female receptacles are formed in a casted part from a corresponding male core pin on a die used for the casting process. The core pin female receptacle(s) in the cast part are inspected for quality control, after which the receptacle may be machined (e.g., tapped) for receiving a corresponding male part (e.g., such as a bolt or screw). The casted part is then provided into a product, such as a vehicle under assembly (e.g., the cast part could be part of an engine, transmission, or a body part for example).

Conventional approaches for determining whether such castings are within tolerance for quality control tend to include manual inspections, such as inspections of the core pin receptacles using marked jigs to determine whether the receptacle is straight and of sufficient depth. However, these manual methods are labor intensive and can miss out-of-tolerance conditions if the jig is improperly inserted, bent, or otherwise misused. For example, if a jig is pushed into the receptacle with too much force, the jig may bend, giving an erroneous reading of the depth of that receptacle, and other receptacles for which the jig us used to inspect. It is also relatively easy to misread the jig markings. This may cause a faulty part to be improperly passed or a quality part to be improperly rejected, and reduces the chance of finding and repairing or replacing faulty dies. Thus under such a process, quality control is less than optimal and is inefficient.

### SUMMARY

Provided are a plurality of example embodiments, including, but not limited to, a method of manufacturing parts, comprising the steps of:
casting a part having a receptacle resulting from using a die comprising at least one core pin;
automatically measuring the depth of the receptacle in the part;
automatically recording a result of the step of automatically measuring the depth of the receptacle;
automatically measuring at least one angle of the receptacle;
automatically recording the result of automatically measuring the at least one angle of the receptacle; and
automatically determining whether the receptacle is acceptable by examining at least one of the measured depth and/or the measured at least one angle of the receptacle.

Also provided is a method of manufacturing parts, comprising the steps of:
casting a part having a receptacle resulting from using a die comprising at least one core pin;
automatically measuring, using a probe of a coordination measurement machine, the depth of the receptacle in the part;
automatically recording a result of the step of automatically measuring the depth of the receptacle;
automatically measuring, using the probe or another probe of the coordination measurement machine, at least one angle of the receptacle;
automatically recording the result of automatically measuring the at least one angle of the receptacle; and
automatically determining whether the receptacle is acceptable by comparing the measured depth and angle(s) of the receptacle with corresponding threshold values of acceptable depth(s) and angle(s).

Further provided is a method of inspecting a part having at least one receptacle formed from a corresponding die having at least one core pin, comprising the steps of:
automatically measuring, using a probe of a coordination measurement machine, the depth of the receptacle of the part, wherein it is determined if the measured depth indicates a broken core pin on the corresponding die;
automatically recording a result of the step of automatically measuring the depth of the receptacle;
if it has not been determined that the receptacle is the result of a broken core pin, performing the steps of:
automatically measuring, using the probe or another probe of the coordination measurement machine, at least one angle of the receptacle, and
automatically recording the result of automatically measuring of the angle(s) of the receptacle;
automatically determining whether the receptacle is acceptable by comparing at least one of the measured depth and/or angle(s) of the receptacle with corresponding threshold values of acceptable depth(s) and/or angle(s);
based on the result of the step of automatically determining whether the receptacle is acceptable, rejecting, accepting, or repairing the casting part; and
determining whether any of the at least one core pin on the die are bent or broken using the result of the step of automatically determining whether the receptacle is acceptable.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 shows an example cast part having a plurality of core pin receptacles;

FIG. 2A shows a cross-section of one core pin receptacle of a portion of the cast part of FIG. 1;

FIG. 2B shows the cross-section of FIG. 1 with the core pin receptacle having been tapped;

FIG. 3 shows an example die with core pins that can be used to form a cast part having core pin receptacles as shown in FIG. 1;

FIG. 4A shows the cross section of an example cast part such as shown in FIG. 1 where the receptacle was formed by a bent core pin on a corresponding die;

FIG. 4B shows a portion of an example cast part where a receptacle was formed from a broken core pin on a corresponding die;

FIG. 5 shows an example coordinate measurement machine (CMM) that can be used to perform an inspection method as disclosed herein;

FIG. 6A shows an example probe that can be used by the CMM of FIG. 5;

FIG. 6B shows the example CMM of FIG. 5 being used to inspect the core pin receptacles of an example cast part;

FIG. 7A is a schematic showing the position of the probe of the example CMM of FIG. 6A as the CMM is about to inspect an example receptacle;

FIG. 7B is a schematic showing example motions of the CMM probe of FIG. 6A during inspection of the example receptacle;

FIG. 8 is a schematic showing the CMM probe of FIG. 6A used for inspecting a receptacle formed using a broken core pin;

FIG. 9A is a flow chart of one example inspection process using the example CMM;

FIG. 9B is a flow chart of another example inspection process using the example CMM;

FIG. 10 shows an example of a flexible probe that can be used by the CMM of FIG. 5;

FIG. 11 is a schematic showing the example flexible probe of FIG. 10 being used by the example CMM for inspecting an example receptacle;

FIG. 12 is a chart summarizing an example inspection operation utilizing the example CMM;

FIG. 13 shows an example excel table of measurement data automatically obtained from an example CMM inspection process;

FIG. 14 shows an example graphical mapping of the results of an example CMM inspection process on a number of the receptacles of an example cast part;

FIG. 15 shows an example of a certain trend analysis for example CMM operations over time; and

FIG. 16 shows a block diagram of one example hardware setup for a system used for performing an example CMM inspection operation.

### DETAILED DESCRIPTION OF THE EXAMPLE EMBODIMENTS

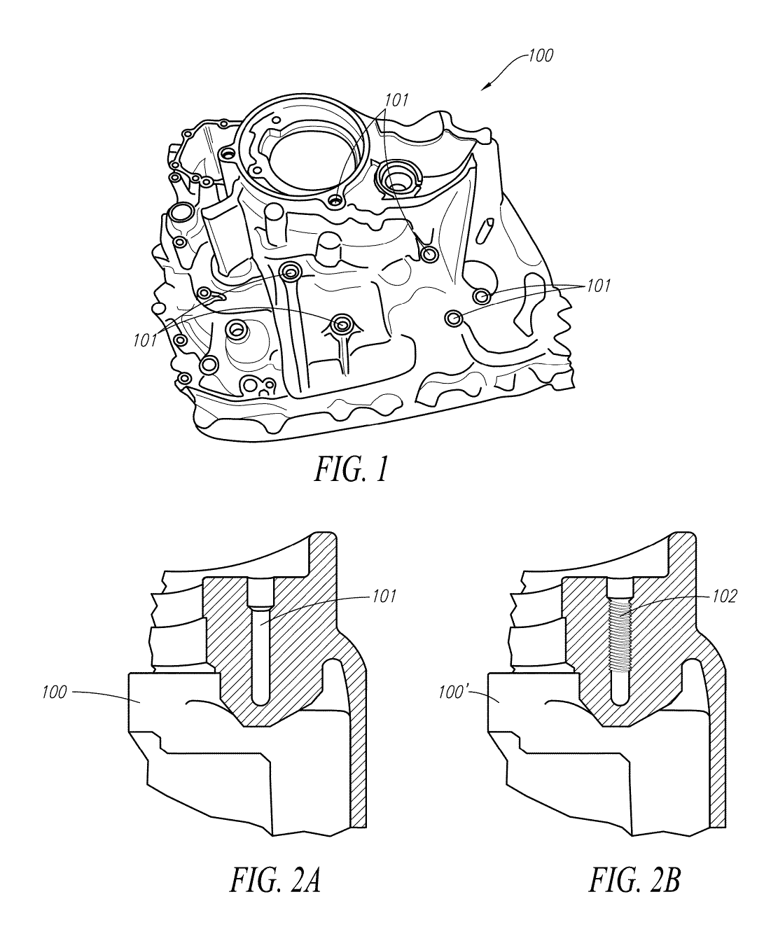

FIG. 1 shows a cast part 100 with various core pin receptacles 101 provided therein. FIG. 2A shows a close-up of a cross-section of one such core pin receptacle 101 in the cast part 100. FIG. 2B shows the cross-section of FIG. 2A where the receptacle 101 of that figure has been tapped to form a tapped receptacle 102 in the machined cast part 100′ such that the tapped receptacle 102 is now adapted to receive a fastener such as a bolt.

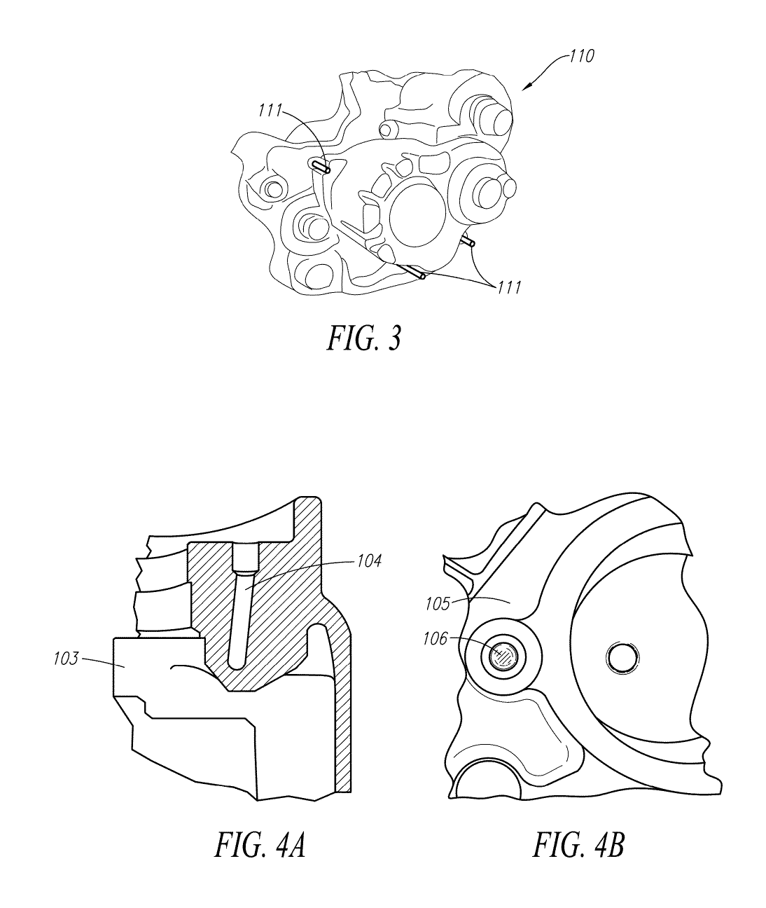

FIG. 3 shows a die 110 used for forming the cast part 100 of FIGS. 1, 2A via a casting process. The die 110 is provided with a plurality of core pins 111 that are used to form the core pin receptacles 101 of the cast part 100 (see FIGS. 1, 2A). These receptacles can then be machined to form tapped receptacles, such as the example shown in FIG. 2B, described above.

FIG. 4A shows a cross-section of a faulty core pin receptacle 104 on a cast part 103. The faulty core pin receptacle 104 was caused by a bent pin on the corresponding die (not shown) used for casting the cast part 103. FIG. 4B shows a cross-section of a faulty core pin receptacle 106 on a cast part 105 that was caused by a broken core pin on the corresponding die (not shown) used for casting the cast part 105. A method of automatically detecting such faulty core pin receptacles 104, 106, among others, is disclosed herein.

Coordinate Measurement Machines (CMM), also known as coordinate measuring machines (among other monikers) can be used as part of a number of procedures in order to measure physical parameters, such as lengths, widths, positioning, and angles of structures and depths and angles of receptacles or other holes, among other measurements. CMM devices can be computer controlled (via user programming in manners known in the art or yet to be developed) to automatically perform such measurements, whereas in other applications, some manual operations of the CMM may be utilized as well (such as manual start positioning of the probe).

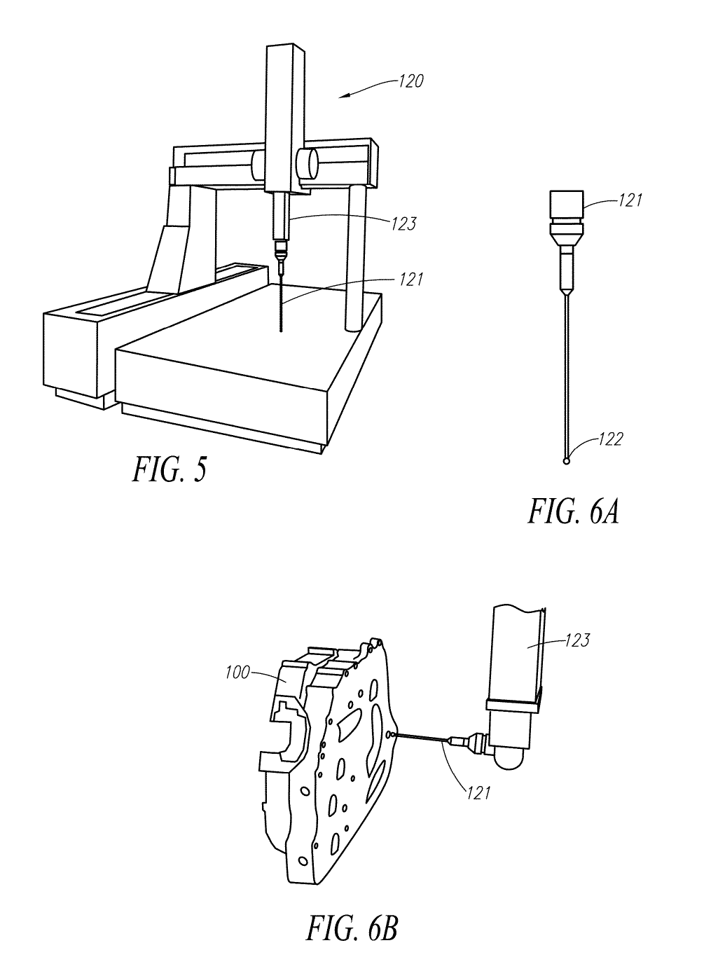

FIG. 5 shows a CMM 120 having an arm 123 and a probe 121 that can be adapted for use in quality checking core pin receptacles, such as described herein. FIG. 6A shows a close-up of the probe 121 having a tip 122 used by the CMM 120 of FIG. 5. FIG. 6B shows the probe 121 attached to the arm 123 of the CMM 120 that is being used to “probe” (i.e., measure or otherwise inspect) a portion of the cast part 100 having the plurality of core pin receptacles described above.

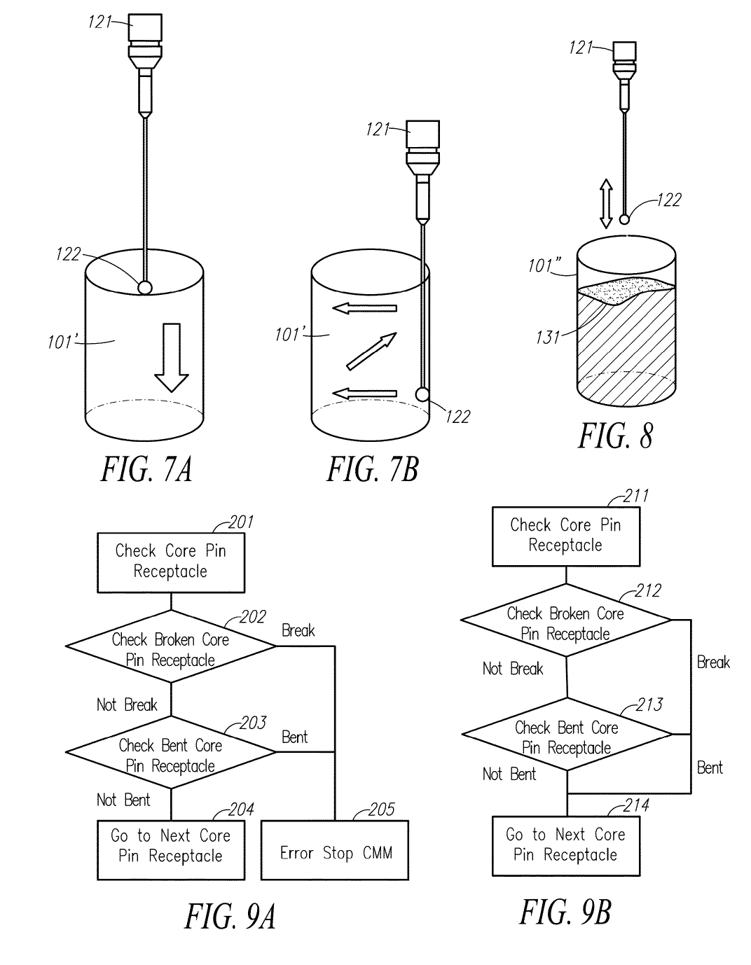

FIG. 7A shows a schematic of the tip 122 of the probe 121 of the CMM 120 that is placed in position to measure (inspect) a receptacle 101′. FIG. 7B shows the tip 122 of the probe 121 of the CMM 120 entering the receptacle 101′ along a side to measure the size, depth, and the angle of the receptacle 101′ such as by using motions shown by the arrows in the figure. By moving the probe tip 122 across the receptacle 101′, the width of the receptacle 101′ can be measured, and similarly the circumference of the receptacle 101′ at various depths can be measured by moving the probe around the receptacle 101′ at the various depths. The angle of the receptacle 101′ can be measured by running the tip 122 along one or more sides of the receptacle 101′. In this manner, the dimensions and the orientation of the receptacle 101′ can be accurately determined.

When a computer controlled CMM is utilized, such measurements can be automatically performed by properly programming the CMM (in a manner provided by the manufacturer of the CMM or its controller) for such functions to be replicated in a repeatable and accurate manner for any number of known receptacle locations. Similarly, the probe may be manually located in a receptacle where such receptacles are not easily programmed for automatic detection or location.

FIG. 8 shows a situation where the probe tip 122 of the probe 121 will encounter a faulty receptacle 101″ having a short depth and uneven base caused by a broken core pin on the corresponding die (not shown). In this case, the probe tip 122 will encounter the premature base 131, causing the CMM 120 to report the shorter depth of the faulty receptacle 101″. The actual measured depth of the faulty receptacle 101″ will be compared with the required depth that is typically known in advance (the comparison may be performed automatically via a properly programmed computer or by manually comparing the actual depth with the required depth). Using the results of this comparison, it can be determined that the receptacle 101″ is faulty and hence that the cast part on which the faulty receptacle 101″ is provided does not meet quality requirements, leading potentially to a repair or a discarding of the cast part. Furthermore, repair or discarding of the die with the broken pin, to avoid such errors in future castings, can also be accomplished.

Similarly, as described above, the CMM can measure the angle of the receptacle by following the sides of the receptacle with the probe tip 122. If the CMM detects that at least a part of the sides of the receptacle are at an improper angle, such as where the receptacle has been formed by a bent core pin (see FIG. 4A), such a situation can be manually or automatically determined and reported in a similar manner, and both the cast part, and the die, can be repaired or replaced, as necessary.

FIG. 9A is a flow chart showing one example inspection process using traditional CMM programming techniques, such that when the CMM encounters an unexpected condition, the process leads to an error condition, stopping the CMM operation and notifying an operator of the error. In this process, the receptacle is checked by the CMM using the probe 201, where the receptacle is first checked for a broken core pin condition 202 (i.e., the core pin receptacle is checked for a short depth), and then the receptacle is checked for a bent core pin condition 203 (i.e., the receptacle is checked for an improper angle), and if the receptacle passes both tests, the measurement can be recorded by the CMM computer, and the CMM moves the probe to the next receptacle 204 for measurement. However, if either step 202 or 203 fail, then the CMM moves to an error condition 205, and the CMM measurement process stops.

Note that the procedure of FIG. 9A checks first for the condition of a broken core pin because in that case, the lack of depth of the receptacle could interfere with an angle measurement.

However, the example inspection process shown in FIG. 9A has the shortcoming that an error condition interrupts the CMM measurement process, requiring a reset by the operator, which can delay the entire inspection process (because even if one finds a faulty receptacle, it would be better to document the faulty receptacle and continue measuring other receptacles to optimize the inspection efficiency).

An improved inspection process is shown in FIG. 9B, where the CMM is alternatively programmed in an innovative manner to merely record any error condition that may be detected when inspecting a receptacle, and then automatically proceed to the inspection of a following receptacle (e.g., this can be done through use of an “if” statement in the CMM programming). Hence, in this alternative procedure, the receptacle is checked by the CMM using the probe, where the receptacle is first checked for a broken core pin condition 212 (i.e., the core pin receptacle is checked for a short depth), and then the receptacle is checked for a bent core pin condition 213 (i.e., the receptacle is checked for an improper angle), and if the receptacle passes both tests, the CMM moves the probe to the next receptacle 214.

However, if step 212 fails, the CMM skips step 213 (again, because the lack of depth of the receptacle could interfere with an angle measurement), the CMM records the error condition using the CMM computer and the procedure moves on to the step of checking the next receptacle 214. Similarly, if the CMM detects an erroneous angle in step 213, the error condition is recorded and the procedure moves on to the step of checking the next receptacle 214. Hence, using this alternative process, the error conditions do not interrupt the inspection process and thus the inspection process efficiency is improved.

Of course, there are alternative inspection procedures that could be utilized to obtain similar results, in particular where the use of a particular CMM might have its own limitations or unique requirements. Furthermore, various data (direct and/or derived) of both the passed and failed measurements, along with part numbers, time, dies used, etc. can be recorded for future use, as described below.

In some situations, the depth of the receptacle may be sufficiently deep that the standard CMM probe cannot effectively measure the angle of an angled receptacle, because CMM machines are often mechanically limited in the angle in which they can tilt the probe. In at least one example, this angle is limited to providing a probe angle of about 7.5 degrees off center, which makes it difficult to measure angled receptacles that may tilt at an angle of up to 40 degrees or more.

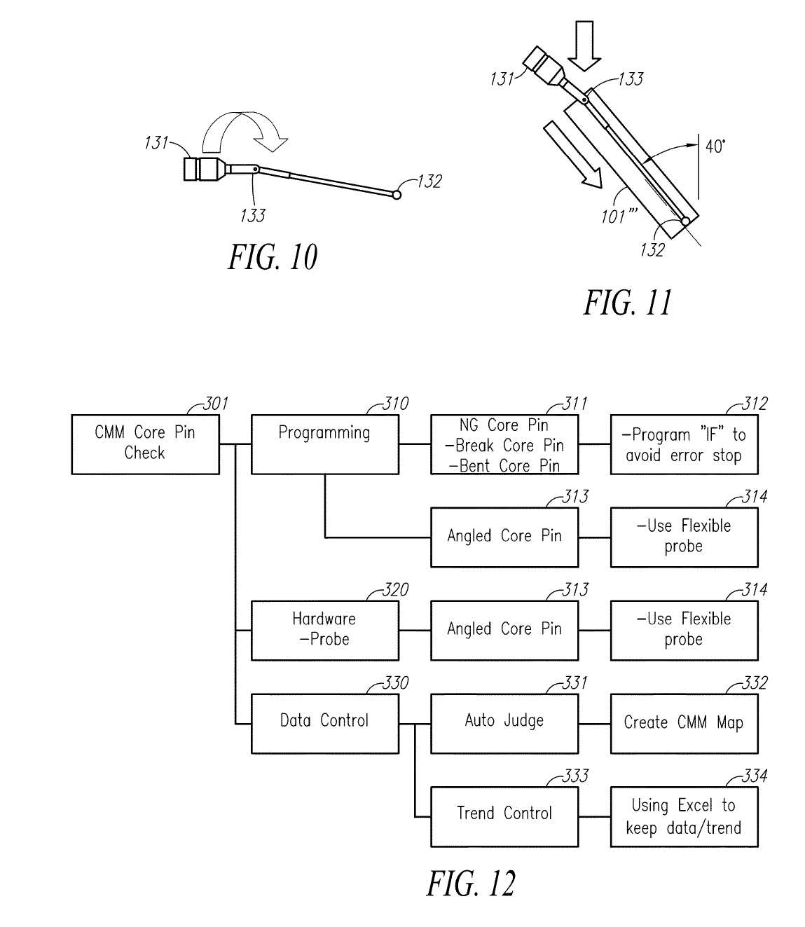

To solve this problem, a flexible probe tip 132 can be provided, such as shown in FIG. 10, where a bendable joint 133 is provided on probe 131 to allow the flexible probe tip 132 to measure deep angled receptacles. FIG. 11 shows the operation of such a flexible probe 132 being used to measure an angled receptacle 101′″. However, because the use of the flexible probe 132 may not be desirable in situations where it is not needed, the CMM can be adapted to use a plurality of different probe types with programming for manually for automatically selecting the appropriate probe for the current desired measurement. For example, when the CMM detects (or is programmed to expect) an angled receptacle, it may swap the normal probe for a flexible probe to complete the measurement of the angled receptacle.

As discussed above, the operation of the CMM can be substantially automated by using a CMM that has programmable computer control. Such automation allows the inspection process to record the inspection data measurements (which may include information derived from the raw measurement data) for automatically determining when a cast part passes the inspection, or when it should be rejected or repaired. Likewise, the faulty die that formed a faulty cast part can be flagged to be repaired or replaced. Such rejection or repair might be manually processed (such as by stopping the manufacturing process and/or notifying an operator of the problem), or the CMM computer may communicate with other computers in order to automate such processes (such as by removing the faulty cast part from the assembly line and/or automatically replacing the faulty die with a new die).

Furthermore, the recorded inspection data can also be used for more detailed analysis, such as for performing trend analysis on the inspected parts. This may be done automatically using computer programs, or manually by using spreadsheets, for example. Such trend analysis can be used to monitor quality control of the cast parts and the dies over time, leading to repair or replacement of the parts, and even repair or replacement of the dies in advance of their causing costly problems to the castings.

FIG. 12 shows a chart summarizing an example inspection operation 301 utilizing the CMM for an inspection process where the example process incorporates many of the alternatives discussed above. The CMM is programmed 310 to convert a stop operation 311 of a core pin that is not good to avoid an error 312, and to avoid problems measuring an angled receptacle 313 by using a flexible probe 314, which is solved by the addition of hardware 320. As discussed, data control 330 can also be programmed into an analysis computer to automatically detect pass/fail of the inspected parts 331, which may use a CMM map 332 to show actual locations of the inspection results, and to perform trend control 333, such as by using a spreadsheet 334 to track the trends.

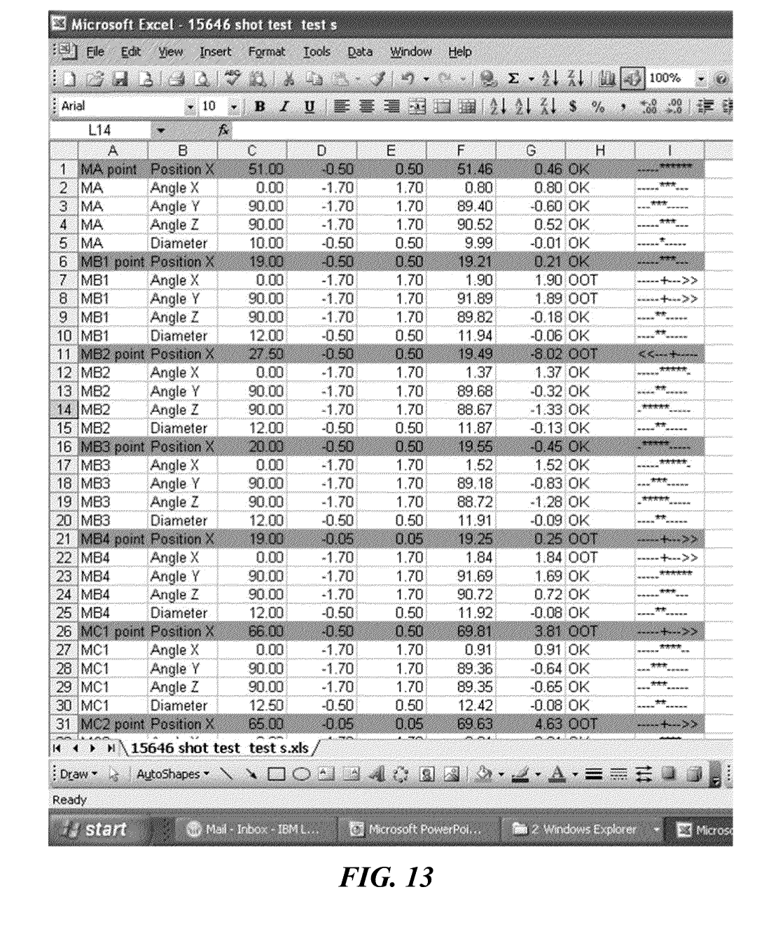

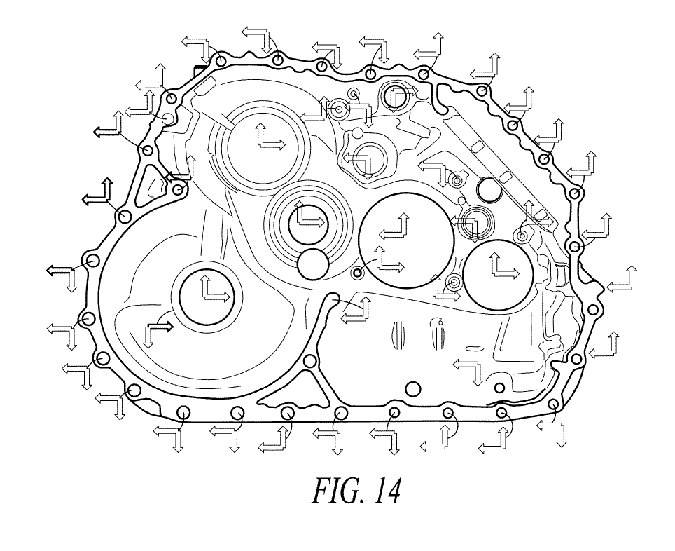

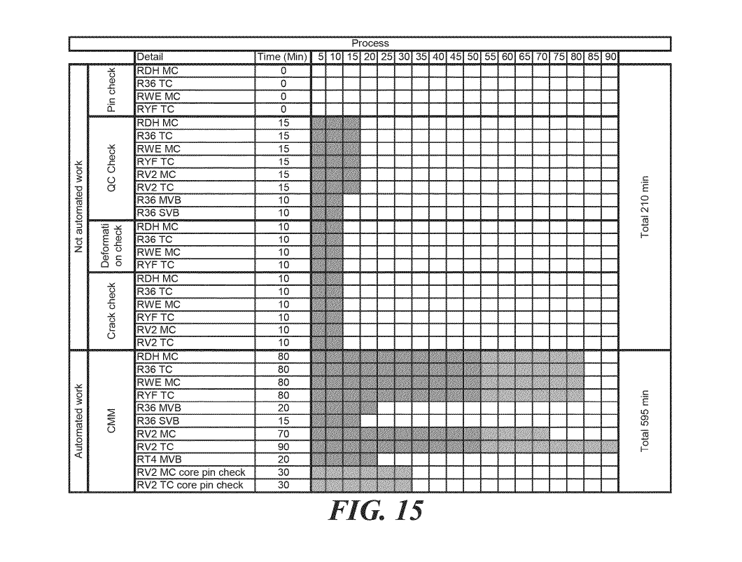

In addition, the collected data can be used to prepare displays for operators and/or inspectors that indicate the status of the inspection operation, the status of current cast part, the status of the die, various trend analyses, and operator workloads, for example. As examples, FIG. 13 shows an excel table of measurement data automatically obtained from an example CMM inspection process; FIG. 14 shows an example graphical mapping of the results of an CMM inspection process on a number of the receptacles of a cast part, with the mapping being displayed to an operator or other user; and FIG. 15 shows an example display of a certain trend analysis for CMM operations over time. These and other output examples can be provided utilizing the data generated over time by the CMM inspection process described herein.

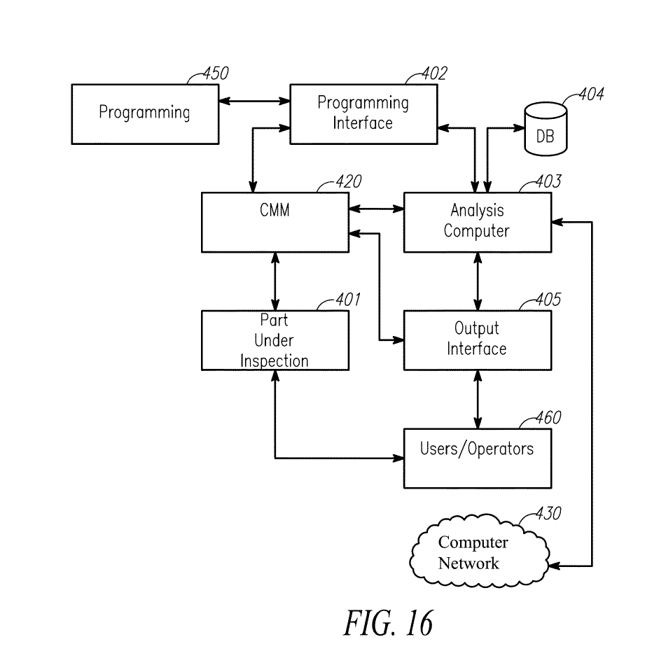

Finally, FIG. 16 shows a block diagram of one example hardware setup for a system used for performing one of the automated CMM inspection procedures as described herein. A CMM machine 420 is used to inspect a plurality of parts 401. The CMM machine 420 is programmed by a programmer 450 using a programming interface 402 (which may be a computer terminal, for example). An additional analysis computer 403 can be provided to analyze the data collected by the CMM 420, which can be stored over time in a database 404. The analysis computer 403 may also be programmed by the programmer 450 using the programming interface 402, or another interface connected to the analysis computer 403, which may be further connected to a network interface 430 for connecting to other computers, for example. The CMM 420 may also be connected to the computer interface 430, which may also act as the means for connecting other computers and interfaces used in this system together.

The analysis computer 403, and/or the CMM 420 directly, may display inspection results, mappings, and/or trend analysis to users/operators 460 using an output interface 405, which could be a computer terminal, for example. Alternatively, the CMM may have programmable analysis capability, in which case the analysis computer 403 may not be needed.

Alternative hardware implementations can also be utilized, and various portions of this system design may be located remotely or locally, as desired.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A method of manufacturing parts, comprising the steps of:
casting a part having a receptacle resulting from using a die comprising at least one core pin;
automatically measuring the depth of the receptacle in the part;
automatically recording a result of the step of automatically measuring the depth of the receptacle;
automatically measuring at least one angle of said receptacle;
automatically recording the result of automatically measuring the at least one angle of the receptacle; and
automatically determining whether said receptacle is acceptable by examining at least one of the measured depth and/or the measured at least one angle of the receptacle.

2. The method of claim 1, wherein said method is performed on a plurality of parts over time, and wherein said method further comprises the step of preparing a trend analysis using stored receptacle depth and/or angle measurements from the plurality of parts over time.

3. The method of claim 1, wherein said step of automatically measuring the depth of the receptacle is performed using a probe of a coordinate measurement machine.

4. The method of claim 3, wherein said step of automatically measuring the at least one angle of said receptacle is performed using another probe of the coordinate measurement machine.

5. The method of claim 1, wherein said step of automatically measuring the at least one angle of said receptacle is performed using a probe of a coordinate measurement machine.

6. The method of claim 1, further comprising the step of, based on the result of the step of automatically determining whether said receptacle is acceptable, rejecting, accepting, or repairing the casting part.

7. The method of claim 1, wherein said step of automatically measuring the depth of the receptacle is performed prior to said step of automatically measuring the at least one angle of said receptacle.

8. The method of claim 1, wherein the method is performed on each one of a plurality of receptacles on said part formed by a plurality of corresponding core pins on said die.

9. The method of claim 1, further comprising the step of determining whether any of said at least one core pin on the die are bent or broken using the result of said step of automatically determining whether said receptacle is acceptable.

10. The method of claim 1, further comprising the step of determining whether any of said at least one core pin on the die are bent based on the result of said step of automatically measuring at least one angle of said receptacle.

11. The method of claim 1, further comprising the step of determining whether any of said at least one core pin on the die are broken using the result of said step of automatically measuring the depth of a receptacle.

12. A method of manufacturing parts, comprising the steps of:
casting a part having a receptacle resulting from using a die comprising at least one core pin;
automatically measuring, using a probe of a coordination measurement machine, the depth of the receptacle in the part;
automatically recording a result of the step of automatically measuring the depth of the receptacle;
automatically measuring, using said probe or another probe of said coordination measurement machine, at least one angle of said receptacle;
automatically recording the result of automatically measuring the at least one angle of the receptacle; and
automatically determining whether said receptacle is acceptable by comparing the measured depth and angle(s) of the receptacle with corresponding threshold values of acceptable depth(s) and angle(s).

13. The method of claim 12, further comprising the step of determining whether any of said at least one core pin on the die are bent or broken using the result of said step of automatically determining whether said receptacle is acceptable.

14. The method of claim 12, further comprising the step of determining whether any of said at least one core pin on the die are bent based on the result of said step of automatically measuring at least one angle of said receptacle.

15. The method of claim 12, further comprising the step of determining whether any of said at least one core pin on the die are broken using the result of said step of automatically measuring the depth of a receptacle.

16. The method of claim 12, wherein said method is performed on a plurality of parts over time, and wherein said method further comprises the step of preparing a trend analysis using stored receptacle depth and/or angle measurements from the plurality of parts over time.

17. The method of claim 12, further comprising the step of, based on the result of the step of automatically determining whether said receptacle is acceptable, rejecting, accepting, or repairing the casting part.

18. The method of claim 12, wherein said step of automatically measuring the depth of the receptacle is performed prior to said step of automatically measuring the at least one angle of said receptacle.

19. The method of claim 12, wherein the method is performed on each one of a plurality of receptacles on said part formed by a plurality of corresponding core pins on said die.

20. The method of claim 12, wherein the step of automatically measuring at least one angle of said receptacle is done using another probe that is flexible.

21. A method of inspecting a part having at least one receptacle formed from a corresponding die having at least one core pin, comprising the steps of:
automatically measuring, using a probe of a coordination measurement machine, the depth of the receptacle of the part, wherein it is determined if the measured depth indicates a broken core pin on the corresponding die;
automatically recording a result of the step of automatically measuring the depth of the receptacle;
if it has not been determined that the receptacle is the result of a broken core pin, performing the steps of:
automatically measuring, using said probe or another probe of said coordination measurement machine, at least one angle of said receptacle, and
automatically recording the result of automatically measuring of the angle(s) of the receptacle;
automatically determining whether said receptacle is acceptable by comparing at least one of the measured depth and/or angle(s) of the receptacle with corresponding threshold values of acceptable depth(s) and/or angle(s);
based on the result of the step of automatically determining whether said receptacle is acceptable, rejecting, accepting, or repairing the casting part; and
determining whether any of said at least one core pin on the die are bent or broken using the result of said step of automatically determining whether said receptacle is acceptable.
